(19) United States
(12) Patent Application Publication
(10) Pub. No.: US 2025/0028856 A1
(43) Pub. Date: Jan. 23, 2025

(54) CRYPTOGRAPHIC AGILITY FOR MULTI-LEVEL PRIVACY-PRESERVING DATA AGGREGATION

(71) Applicant: VMware LLC, Palo Alto, CA (US)

(72) Inventors: Sean HUNTLEY, Sydney (AU); David OTT, Chandler, AZ (US); Daniel James BEVERIDGE, Valrico, FL (US); Martin Patrick STACK, Folsom, CA (US)

(21) Appl. No.: 18/355,562

(22) Filed: Jul. 20, 2023

(51) Int. Cl. G06F 21/62; G06F 21/60

(52) U.S. Cl. CPC G06F 21/6245; G06F 21/602

(57) ABSTRACT

The disclosure provides an approach for cryptographic agility for multi-layer privacy-preserving data aggregation. Embodiments include receiving a request for dynamic cryptographic technique selection related to a data aggregation process involving a first aggregator device and a second aggregator device performing one or more computations on data provided from multiple endpoints. Embodiments include determining, based on contextual information, that the second aggregator device is associated with a confidential computing component and that the first aggregator device is not associated with any confidential computing component. Embodiments include selecting one or more homomorphic encryption techniques for protecting the data while in use by the first aggregator device based on the determining that the first aggregator device is not associated with any confidential computing component and selecting a confidential computing technique for protecting the data while in use by the second aggregator device.

### BACKGROUND

Cryptography generally involves techniques for protecting data from unauthorized access. For example, data transmitted over a network may be encrypted in order to protect the data from being accessed by unauthorized parties. For example, even if the encrypted data is obtained by an unauthorized party, if the unauthorized party cannot decrypt the encrypted data, then the unauthorized party cannot access the underlying data. There are many types of cryptographic algorithms, and these algorithms vary in many aspects such as key size, ciphertext size, memory requirements, computation requirements, amenability to hardware acceleration, failure handling, entropy requirements, and the like. Key size refers to the number of bits in a key used by a cryptographic algorithm. Key size affects the strength of a cryptographic technique and is a configuration parameter. Having more bits in a key size results in more computation, but a larger space of possible mappings from cleartext to ciphertext, which is a quality makes it harder for an adversary to guess a key having a larger number of bits.

Ciphertext size refers to the number of bits in the output from a cryptographic algorithm, which may be the same as the number of bits of the input or may include a larger number of bits than the input. Memory requirements and computation requirements generally refer to the amount of memory and processing resources required to perform an algorithm. Amenability to hardware acceleration generally refers to whether an algorithm requires or can be improved through the use of a hardware accelerator. For example, a compute accelerator is an additional hardware or software processing component that processes data faster than a central processing unit (CPU) of the computer. Failure handling refers to the processes by which an algorithm accounts for failures, such as recovering keys that are lost or deactivated. Entropy requirements generally refer to the amount of randomness required by an algorithm, such as an extent to which randomly generated values are used as part of the algorithm (e.g., which generally improves security of the algorithm).

Data aggregation generally involves receiving multiple items of data, such as from different data sources, and performing one or more computations in order to produce an aggregated result based on the multiple items of data. One example of data aggregation is federated learning, which generally refers to techniques in which an algorithm (e.g., a machine learning algorithm, in the case of federated machine learning) is trained across multiple decentralized edge devices or servers that hold local data without exchanging the local data between the edge devices. In one example, edge devices perform local data processing and provide results to an aggregator device, which aggregates the results among the multiple edge devices to update a centralized result, which can then be re-distributed to the edge devices for subsequent training and/or use. Cryptography may be used in a data aggregation process (e.g., federated learning) in order to protect data (e.g., model parameters such as weights and biases, or other types of data) during transmission, such as between edge devices and an aggregator device. For example, edge devices may encrypt local data before sending it to the aggregator device, such as sharing an encryption key with the aggregator device via a separate secure channel, and the aggregator device may encrypt a final result of aggregation (e.g., a centralized model) in a similar manner before sending it back to the edge devices. Furthermore, certain data aggregation processes may involve multiple levels of aggregation, involving the use of multiple aggregator devices with different capabilities, constraints, and levels of trust.

While existing data aggregation techniques may protect data during transmission between endpoints, these techniques require the endpoints to be trusted with access to the unencrypted data. For example, an aggregator device must be trusted to access the local data from all participating edge devices. Furthermore, existing data aggregation techniques rely on fixed cryptographic techniques, such as those that the software applications performing the operations related to data aggregation are configured to support, and these fixed cryptographic techniques may not be optimal for the varying contexts in which data aggregation techniques are performed, such as for the different levels of a multi-level data aggregation process.

As such, there is a need for improved techniques for secure and performant data aggregation.

### BRIEF DESCRIPTION OF THE DRAWINGS

FIG. 1 is an illustration of example computing components related to cryptographic agility for multi-level privacy-preserving data aggregation, according to embodiments of the present disclosure.

FIG. 2 is an illustration of an example related to dynamic cryptographic technique selection for privacy-preserving data aggregation.

FIG. 3 is an illustration of an example related to cryptographic agility for multi-level privacy-preserving data aggregation.

FIG. 4 depicts an example of tagging cryptographic techniques based on parameters related to multi-level privacy-preserving data aggregation.

FIG. 5 depicts example operations for cryptographic agility for multi-level privacy-preserving data aggregation according to embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure relates to cryptographic agility for privacy-preserving data aggregation. In particular, the present disclosure provides an approach for dynamically selecting cryptographic techniques, such as homomorphic encryption techniques and confidential computing techniques, for use at each level of a multi-level privacy-preserving data aggregation process based on parameters related to the multi-level privacy-preserving data aggregation process. In certain embodiments, a confidential computing environment such as a secure enclave is used when available (e.g., at one or more aggregator devices), while other privacy-preserving cryptographic techniques such as homomorphic encryption techniques are used in other cases (e.g., for protecting the privacy of data while in use at one or more other aggregator devices that do not support confidential computing techniques).

Cryptographic agility generally refers to techniques for dynamic selection and/or configuration of cryptographic algorithms. According to certain embodiments, logic related to selection and/or configuration of cryptographic algorithms is decoupled from the applications that utilize cryptographic functionality, and is implemented in one or more separate components. Thus, rather than an application directly calling a cryptographic library to perform cryptographic functionality, the application may call generic cryptographic functions provided by a separate cryptographic agility system, and the cryptographic agility system may then select and/or configure cryptographic algorithms, such as based on contextual information and/or policies. For instance, the cryptographic agility system may dynamically determine which libraries, algorithms, configuration values, and/or the like to select based on factors such as the type of data being encrypted, the type of application requesting encryption, the network environment(s) in which the data is to be sent, a destination to which encrypted data is to be sent, geographic locations associated with a source and/or destination of the data, attributes of users associated with the encryption, regulatory environments related to the encryption, network conditions, resource availability, performance constraints, device capabilities, and/or the like.

According to embodiments of the present disclosure, cryptographic techniques are dynamically selected based on attributes related to a privacy-preserving data aggregation process (e.g., a federated learning process), such as whether an aggregator device is trusted to access the data being aggregated, whether the aggregator device has one or more types of hardware required for confidential computing, based on the mathematical operations to be performed by an aggregator device in order to produce an aggregated result (e.g., in the case of homomorphic encryption), resource constraints, and/or the like.

Examples of privacy-preserving data aggregation processes include federated learning, industrial information aggregation (e.g., processes in which data from multiple endpoints is aggregated without any result of the aggregation being sent back to the endpoints), and/or the like. Embodiments of the present disclosure may be employed for any type of process in which data from multiple endpoints is aggregated, whether federated learning, information aggregation in which results of aggregation are not sent back to the endpoints, or another type of data aggregation. In certain cases, a data aggregation process may be “multi-level” such that data is aggregated at different hierarchical levels by multiple aggregator devices.

One or more aggregator device smay in some cases not be trusted with access to data being aggregated. For example, if local model gradients, parameter data, and/or participant data are sent from a plurality of endpoints to an aggregator device for aggregation, there is a possibility that sensitive local data could be reconstructed from these data points. Furthermore, such data may be vulnerable to side channel attacks or insider attacks at the aggregator device. A compromised operating system or other software associated with the aggregator device could also gain access to sensitive data while it is being processed at the aggregator device.

In a particular example, different types of confidential computing techniques and/or homomorphic encryption algorithms may be dynamically selected for privacy-preserving data aggregation based on a variety of factors. For example, while many cryptographic techniques involve encrypting data at the source and decrypting the data at the destination in order to protect the privacy of the data during transmission, confidential computing and homomorphic encryption techniques provide an additional benefit of preserving the privacy of the data while it is processed at the destination (e.g., data in use), thereby allowing for arrangements in which the data is never decrypted at the destination (e.g., except within a confidential computing environment in the case of confidential computing).

Confidential computing generally refers to computing techniques that isolate sensitive data in a protected processor enclave during processing. Some confidential computing environments includes “attestation” mechanisms that provide robust proofs of the underlying platform and the identity/integrity of what is loaded into the protected enclave, while other confidential computing environments may not include such mechanisms. The enclave may be referred to as a trusted execution environment (TEE). The contents of the enclave, including the data that is processed and the logic used to process the data, are accessible only to authorized programming code, and are invisible and in accessible to any other components outside of the enclave. Such an enclave or TEE may be an example of a confidential computing component as discussed herein. Confidential computing provides many advantages, such as the ability to perform computations on sensitive data without exposing the sensitive data to any entities outside of the secure enclave, including not exposing the sensitive data to any other components of the device on which the secure enclave is located and/or to an entity that operates such a device (e.g., a cloud provider). Furthermore, confidential computing is generally resource-efficient with respect to processor, memory, and network resources (e.g., as compared to resource-intensive techniques such as fully homomorphic encryption or secure multiparty computation). However, confidential computing requires specialized hardware (e.g., a secure processor enclave), and so cannot be performed in the absence of such hardware.

Homomorphic encryption generally refers to encryption techniques that allow one or more types of mathematical operations to be performed on encrypted data without decryption and without exposing the underlying data. With homomorphic encryption, the result of performing a mathematical operation on the encrypted data remains in an encrypted form which, when decrypted, results in an output that is identical to that produced had the mathematical operation been performed on the unencrypted data. Homomorphic encryption techniques can be resource-intensive with respect to processor, memory, and network resources, but do not generally require specialized hardware.

According to techniques described herein, selecting a homomorphic encryption technique for use in a secure aggregation process allows an aggregator device to perform computations on encrypted data received from multiple endpoints (e.g., edge devices) without the aggregator device being granted access to the unencrypted data, and thereby preserving the privacy of the underlying data, while producing an aggregated result that can be decrypted by the endpoints as if the computations had been performed on the unencrypted data. Thus, using homomorphic encryption protects the “data in use” from being leaked or tampered with. Normally, the aggregator must decrypt data that it receives in order to perform computations, and this creates a vulnerability that allows the data be attacked by malicious software, side channel attacks, insider attacks, and/or the like. Homomorphic encryption allows computations to be performed on the encrypted data (e.g., without decrypting the data), thereby avoiding such vulnerabilities. For example, if local models at multiple edge devices are being trained based on local data that is sensitive and yet there is a desire to train a global model that is not biased by the potentially unique attributes of the local data, the edge devices may encrypt their local model parameters (e.g., gradients) using homomorphic encryption and then send the encrypted local model parameters to the aggregator device for aggregation in a privacy-preserving manner. The aggregator device may perform computations on the encrypted local model parameters received from the edge devices in order to determine global model parameters (which will remain encrypted). The global model parameters, when sent back to the edge devices, can be decrypted using the same homomorphic encryption key or keys used to encrypt the local model parameters in order to produce an unencrypted global model at the edge devices. In cases where multiple levels of aggregation are performed by multiple aggregation devices and secure cryptographic translation is performed, as described in more detail below, additional logic may be needed to ensure that the global model parameters can ultimately be decrypted by the edge devices upon receipt, such as reverse cryptographic translation of global model parameters, sharing of homomorphic encryption key(s) among specific components, and/or the like.

There are different types of homomorphic encryption algorithms that support different types of mathematical operations. For example, some homomorphic encryption algorithms only allow addition to be performed on the encrypted data, some homomorphic encryption algorithms allow multiplication to be performed on the encrypted data, and some homomorphic algorithms are “fully homomorphic” such that they support the full range of possible mathematical operations on the encrypted data. Generally, a fully homomorphic encryption algorithm allows the evaluation of arbitrary circuits composed of multiple types of gates of unbounded depth and is the strongest notion of homomorphic encryption.

Different homomorphic encryption algorithms have different levels of security and/or vary in the amount of computing resources (e.g., processing, memory, and/or network resources) that are utilized during encryption, decryption, and transmission of encrypted data. For example, fully homomorphic encryption algorithms are generally resource-intensive, and so cannot be used on devices with limited available computing resources. Furthermore, there are many different types of fully homomorphic encryption techniques and many different types of partially homomorphic encryption techniques, including many different potential configurations of many different potential algorithms associated with many different potential libraries, and selection among these different techniques may be based on a variety of factors, such as the mathematical operations to be performed, the resource-efficiency of these techniques, the level of security of these techniques, attacks protected against, device limitations, and/or the like. When determining whether to select a fully homomorphic encryption technique or a partially homomorphic encryption technique, a cryptographic agility system as described herein may consider the cost in computing resources given the nature of the aggregation to be performed, the availability of acceleration hardware that could be utilized for particular types of homomorphic encryption (e.g., fully homomorphic encryption), device hardware provisioning, and/or the like.

Additionally, there may be many different types of confidential computing, including different technologies (e.g., different secure enclaves), different libraries, different confidential computing based aggregation libraries, and/or the like.

Thus, according to embodiments of the present disclosure, different types of privacy-preserving cryptographic techniques, including but not limited to confidential computing techniques and homomorphic encryption techniques, may be dynamically selected for different levels of a multi-level data aggregation process based on, for example, whether specialized hardware required for certain confidential computing techniques is available, the resource constraints of one or more aggregator devices, which mathematical operations are to be performed by the one or more aggregator devices, required level(s) of security with respect to the one or more aggregator devices, and/or the like. For example, when determining whether to select a confidential computing technique, a cryptographic agility system as described herein may consider the availability of the required technology on the platform (e.g., whether a secure enclave is present), the amounts of resources available (e.g., memory size and computation capacity), whether attestation can successfully be performed (e.g., if the aggregator device has the capability to attest to the accuracy and confidential nature of computations that are performed), availability of confidential computing libraries and secure aggregation implementations, and/or the like.

In some cases, a mix of confidential computing and homomorphic encryption may be selected for handling a particular cryptographic request, such as using one or more confidential computing techniques for some operations and using one or more homomorphic encryption techniques for other operations. In some cases, different types of cryptographic techniques may be used for protecting data while in use at different aggregator devices involved in a multi-level data aggregation process.

The cryptographic agility system may, for instance, determine estimated processing requirements, memory requirements, device requirements, and the like for different cryptographic techniques, such as based on tags associated with the cryptographic techniques, and may use this information in conjunction with information about available processing resources, available memory resources, device capabilities, and the like for devices that are to perform cryptographic operations in order to dynamically select cryptographic techniques for particular circumstances, such as for particular data aggregation processes.

In certain embodiments different cryptographic techniques (e.g., homomorphic encryption techniques) may be selected for different aggregator devices involved in a single data aggregation process based on factors that differ between the aggregation devices. For example, different aggregator devices may have differing resource constraints and capabilities, differing abilities with respect to confidential computing (e.g., some aggregator devices may have confidential computing components while others may not), differing security requirements (e.g., based on locations or organizations with which the aggregator devices are associated), may perform differing mathematical operations (e.g., if multiple layers of aggregation are involved and different operations are performed at different layers), and/or the like. Thus, techniques described herein may be involve the utilization of multiple privacy-preserving cryptographic techniques, including switching between such techniques in a privacy-preserving manner, such as by using homomorphic encryption techniques (or other privacy-preserving encryption) for protecting data while in use by aggregator devices that do not support confidential computing and then securely decrypting such homomorphically-encrypted data within a confidential computing environment for performing computations on one or more aggregator devices that do support confidential computing (e.g., and then re-encrypting a result of such computations within the confidential computing environment using either a homomorphic or non-homomorphic encryption technique such that the unencrypted data is never accessed by the aggregator device outside of the confidential computing environment).

Furthermore, some embodiments involve using a confidential computing environment for cryptographic translation in order to allow a device to decrypt encrypted data and re-encrypt the data using a different encryption technique, within a secure environment, all without the device otherwise being granted access to the unencrypted data, and thereby preserving the privacy of the underlying data. For example, a cryptographic translator server may provide such privacy-preserving cryptographic translation as a service, such as allowing endpoints to request privacy-preserving cryptographic translation via one or more application programming interface (API) calls.

In one example, local ML models at multiple edge devices are being trained based on local data that is sensitive (e.g., medical information, personally identifiable information (PII), classified information, private user data, and/or the like) and yet there is a desire to train a global model that is not biased by the potentially unique attributes of the local data. Continuing the example, the local data from the edge devices is to be aggregated at two different aggregator devices, such as corresponding to different hierarchical levels of aggregation. A first cryptographic technique is selected for the first aggregator device based on one or more attributes related to the first aggregator device and a second cryptographic technique is selected for the second aggregator device based on one or more attributes related to the second aggregator device. For instance, the second aggregator device may aggregate results of aggregation performed by the first aggregator device with data from one or more additional endpoints, and may require a different level of security, may perform different mathematical operations, may have different device capabilities (e.g., a confidential computing component), and/or may have different resource constraints than the first aggregator device. In one example, a homomorphic encryption technique that supports only addition is selected for the first aggregator device (e.g., because the first aggregator device does not provide confidential computing functionality and because the first aggregator is only going to perform addition operations as part of the data aggregation process) while a confidential computing technique is selected for the second aggregator device (e.g., because the second aggregator device is associated with a confidential computing component).

At least a subset of the edge devices may encrypt their local model parameters (e.g., gradients) using the first cryptographic technique, and confidentially share an encryption key directly with a confidential computing environment on the second aggregator device via a secure channel, and then send the encrypted local model parameters to the first aggregator device for aggregation. The first aggregator device may perform computations on the encrypted local model parameters received from the edge devices without decrypting the data (e.g., due to the homomorphic nature of the encryption) and then may send the result of the computations, which remains encrypted, to the second aggregator device.

The second aggregator device then performs aggregation operations within the confidential computing environment, such as decrypting the encrypted results received from the first aggregator device using the encryption key received from one or more of the edge devices, performing computations on the decrypted data (e.g., aggregating the decrypted data with other data received from one or more other endpoints) and re-encrypting the results of the computations (e.g., using the encryption key received from one or more of the edge devices or using an entirely different cryptographic technique such as a non-homomorphic encryption technique). The underlying data is never accessible on the second aggregator device outside of the confidential computing environment, as decryption and re-encryption are performed within the confidential computing environment (e.g., secure enclave).

The re-encrypted results may then be sent on to an additional aggregator device, such as for further aggregation (e.g., in a confidential computing environment) with data received from one or more other endpoints, or the re-encrypted results may be sent back to the first aggregator device (or directly back to the edge devices), and the first aggregator device may send the re-encrypted results back to the edge devices. The results of the aggregation performed by the second aggregator device may be global model parameters. The global model parameters may, in some embodiments, be re-encrypted using the same homomorphic encryption technique with which the data was originally encrypted before being sent to the first aggregator device. When sent back to the edge devices, the global model parameters can be decrypted (e.g., using the same encryption key or keys originally used to encrypt the local model parameters using the first cryptographic technique) in order to produce an unencrypted global model at the edge devices.

Thus, techniques described herein may allow for the use of multiple different cryptographic techniques in a multi-level privacy-preserving data aggregation process, such as enabling the use of different types of encryption for different aggregation points in a data aggregation process. Accordingly, a cryptographic agility system may select algorithms and/or configurations of algorithms that are best suited to the mathematical operations to be performed in the data aggregation process and, in some embodiments, to the resource availability, performance, and/or capabilities of the device(s) and/or network(s) associated with the request, including selecting different techniques for different aggregator devices and/or networks in the same data aggregation process. For example, if processing resource availability at a given aggregator device is low (e.g., if processor utilization is high), then ciphers that support the required mathematical operations and yet have low processing requirements may be selected for that aggregator device. In another example, if network latency is high (e.g., for a satellite-based network) or if memory availability is low at a given aggregator device, then ciphers that support the required mathematical operations and yet have smaller key sizes or ciphertext sizes may be selected in order to reduce the amount of data that will need to be stored and/or transmitted over the network to implement the cryptographic algorithm for the given aggregator device.

In some embodiments, a variety of additional factors may also be used to dynamically select an encryption technique for a privacy-preserving data aggregation process. For example, policies may be defined by users (e.g., administrators), and may specify rules for selecting and/or configuring cryptographic (e.g., setting particular parameters) techniques. Policies may specify, for example, conditions under which cryptographic techniques must comply with one or more standards (e.g., Federal Information Processing Standards or FIPS), when a quantum-safe cryptographic technique must be selected, how to select among different quantum-safe cryptographic techniques, conditions for selecting key sizes (e.g., based on a desired level of security or based on different algorithm standards such as particular elliptical curves), and/or the like. In one example, cryptographic techniques (e.g., algorithms and/or configurations of algorithms) are tagged with different levels of security (e.g., rated from 0-10), and a policy associated with an application may specify that all data that is to be transmitted from the application to a destination in a given type of networking environment, such as a public network, is to be encrypted using a high-security algorithm (e.g., rated 8 or higher) for protecting the data during transmission. Thus, if the application calls a function provided by the cryptographic agility system to encrypt an item of data for a data aggregation process, and contextual information indicates that the data is to be transmitted to a device (e.g., an aggregator device) on a public network, then the cryptographic agility system, in certain embodiments, will select a cryptographic technique tagged as a high-security technique, such as with a security rating of 8 or higher, for use in encrypting the data for transmission (e.g., the data may already be encrypted using homomorphic encryption to protect the data while it is in use, and a “transmission” encryption technique may be applied on top of such homomorphic encryption). In one example, data that has already ben encrypted using a homomorphic encryption technique (e.g., that may not be tagged as a high-security algorithm) is then encrypted again using a “transmission” cipher (e.g., transport layer security) such that the receiving endpoint performs decryption to reveal the homomorphically encrypted data. Furthermore, data that is to be aggregated in a confidential computing environment at an aggregator device may be transmitted to the aggregator device in encrypted form using a transmission cipher (e.g., as appropriate, such as if the data has not already been encrypted with a homomorphic encryption technique that satisfies all requirements associated with transmission). In another example, a policy may specify that confidential computing is to be used for all cryptographic requests related to privacy-preserving data aggregation that are associated with a particular geographic region, organization, and/or locality and/or that homomorphic encryption is to be used for all cryptographic requests related to privacy-preserving data aggregation that are associated with another particular geographic region, organization, and/or locality. This may be due to differing preferences with respect to confidential computing and/or homomorphic encryption associated with different regions, countries, organizations, and/or the like. Thus, there may be cases where homomorphic encryption or other types of privacy-preserving encryption techniques may be used even when confidential computing environments are available.

In another example, cryptographic techniques are tagged with indications of whether they comply with particular standards, and a policy may specify that all data associated with a particular application or for a particular purpose is to be encrypted with a cryptographic technique that complies with a particular standard (e.g., FIPS). In such an example, if an application calls a function provided by the cryptographic agility system to encrypt an item of data, and contextual information indicates that the data relates to the particular purpose or that the application is the particular application, then the cryptographic agility system, in certain embodiments, will select a cryptographic algorithm tagged as being compliant with the particular standard.

In yet another example, cryptographic techniques are tagged with indications of whether they have certain characteristics or support certain configurations, and a policy may specify that all data that is to be transmitted as part of a data aggregation process is to be encrypted using a cryptographic technique that does or does not have one or more particular characteristics or configurations. Thus, if the cryptographic agility system receives a request to encrypt an item of data for a data aggregation process, then the cryptographic agility system, in certain embodiments, will select a cryptographic algorithm tagged with indications that the cryptographic algorithm does or does not have the one or more particular characteristics or configurations indicated in the policy. Accordingly, an organization or user may specify policies based on their own preferences of which characteristics or configurations of cryptographic techniques are most secure or desirable and/or based on specific compliance requirements.

By decoupling cryptographic logic from applications that rely on cryptographic functionality for performing privacy-preserving data aggregation operations, cryptographic agility techniques described herein provide flexibility and extensibility, thus allowing cryptographic techniques to be continually updated, changed, and otherwise configured without requiring modifications to the applications themselves, such as allowing for the utilization of new types of confidential computing and/or homomorphic encryption that are not natively supported by the application. Accordingly, changing circumstances may be addressed in a dynamic and efficient manner, and computing security may thereby be improved.

According to embodiments of the present disclosure, cryptographic techniques are dynamically selected and/or configured for use in privacy-preserving data aggregation operations based on additional factors such as network and/or resource constraints. In some cases, a cryptographic algorithm may be referred to as a “cipher”. Cryptographic algorithms have varying resource requirements, such as different memory, processing, and/or communication resource requirements. For example, some algorithms are more computationally-intensive than others and some algorithms involve storage and/or transmission of larger amounts of data than others. For example, algorithms involving larger key sizes or ciphertext sizes generally require larger amounts of memory and/or network communication resources than algorithms with smaller key sizes or ciphertext sizes. In another example, the larger the number of bits of security used in an algorithm, the more processing-intensive the algorithm will generally be.

In a cryptographic agility system, an initial stage of selecting a cryptographic technique may involve ensuring that the security requirements for a given cryptographic operation, such as a level of security required by policy and/or context information, are met. However, there may be multiple algorithms and/or configurations of algorithms that meet these requirements. The requirements for transmission of data may be distinct from the requirements of the encapsulated homomorphically encrypted content which focus on functionality of the homomorphic encryption ciphers, required mathematical operations and such. Thus, techniques described herein involve factoring the availability of specialized hardware, operation-related considerations (e.g., which mathematical operations are to be performed in a data aggregation process), resource-related considerations, and/or the like into the determination of which algorithms and/or configurations to use, such as based on information associated with a request and/or based on device and/or network performance metrics and/or capability information.

Cryptographic techniques may be tagged, such as by an administrator or expert, based on whether they are privacy-preserving, whether they are homomorphic, supported mathematical operations, based on resource requirements, and based on levels of security, threats protected against, and/or the like. For example, a given technique may be tagged with an indication of required hardware, supported mathematical operations (e.g., in the case of homomorphic encryption), and/or with a classification with respect to each of memory requirements, processing requirements, network resource requirements, and/or the like. Classifications may take a variety of forms, such as high, medium, and low, numerical scales (e.g., 0-10), binary indications, and/or the like. In some embodiments, classifications may be imported from one or more sources, such as cryptographic technique providers, open source entities, standards bodies, and/or the like. In some embodiments, rather than individual cryptographic techniques being tagged, types of cryptographic techniques are tagged with attribute such as required hardware, supported mathematical operations and/or classifications relating to various types of resource requirements. In one example, a tag may indicate that all “additive” homomorphic encryption algorithms support addition. In another example, a tag may indicate that all fully homomorphic encryption algorithms are associated with a high processing resource requirement. In yet another example, a tag may indicate that all confidential computing techniques are associated with a low processing resource requirement. In still another example, a tag may indicate that all techniques that involve the use of an accelerator are associated with a high processing resource requirement. An accelerator is a hardware device or a software program that enhances the overall performance of a computer, such as by processing data faster than a central processing unit (CPU) of the computer (e.g., which may be referred to as a compute accelerator). It is noted that CPUs may in some cases have special instructions for accelerating cryptographic operations, such as the Advanced Encryption Standard New Instructions (AES-NI) instruction set from Intel®, and a tag may indicate that a cryptographic technique is or is not compatible with such special instructions. Furthermore, cryptographic techniques may be tagged with indications of capability requirements, such as whether an accelerator and/or other specialized hardware is required.

When a cryptographic request is submitted by an application, the cryptographic agility system may gather information associated with the request (e.g., from the request itself, from metadata associated with the request, and/or through communication with one or more other components) related to a multi-level privacy-preserving data aggregation process. Furthermore, the cryptographic agility system may gather information related to resource conditions and/or capabilities of the network(s) and/or device(s) related to the cryptographic request. For instance, the cryptographic agility system may gather current resource availability (e.g., based on capacity and utilization), performance metrics, capability information, and the like for the device(s) and/or network(s) to which the request relates. Techniques for gathering such information are known in the art and may involve, for example, including contextual information in the cryptographic request, communication with one or more performance monitoring components, communication with the involved devices, and/or the like.

In some cases, multiple cryptographic algorithms and/or configurations of algorithms may be used to service a single cryptographic request and/or for a single aggregator device. For instance, if a new, more secure cryptographic algorithm has recently become available but is not yet certified by a particular organization, and a particular cryptographic request requires cryptography that is certified by the particular organization, a certified algorithm may first be used and then the new algorithm may be used on top of the certified algorithm to provide the added level of security.

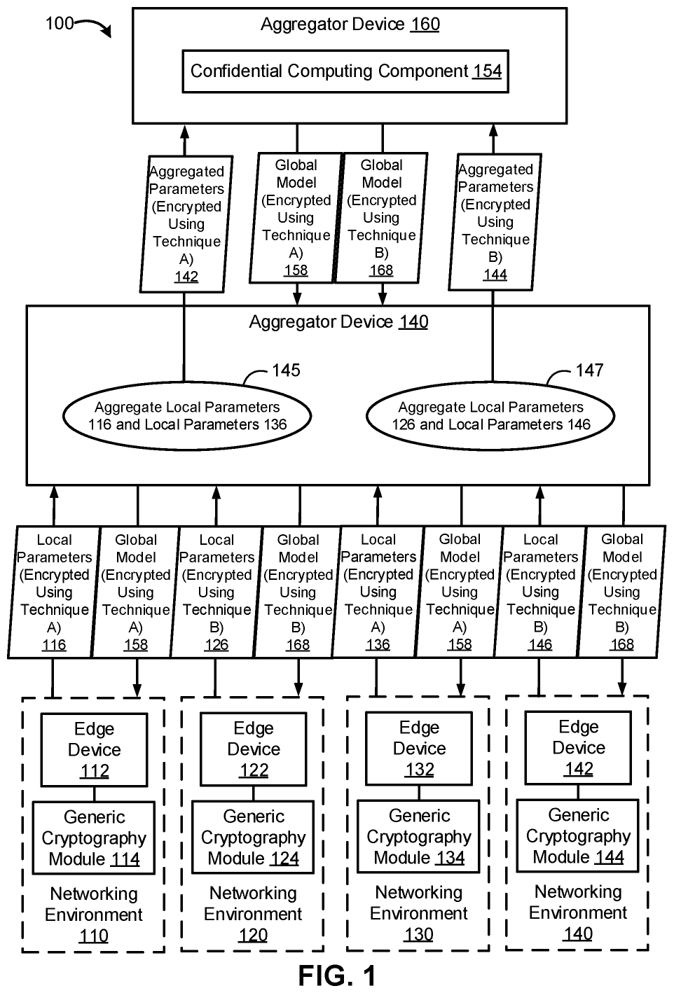

Furthermore, for a federated learning process, the multiple endpoints that send homomorphically encrypted data to an aggregator device may encrypt local data using a single encryption key that is shared across the endpoints (but not with the aggregator device) and/or may use different encryption keys, such as using a multi-key homomorphic encryption scheme (e.g., so that one endpoint is unable to decrypt the local data from another endpoint even if it were to obtain such local data). In other embodiments, as described in more detail below with respect to FIG. 1, groups of endpoints may use different encryption techniques (e.g., different homomorphic encryption techniques that are selected based on differing constraints), such that data from one group is aggregated separately from data from another group, and then the results of the separate aggregations may be aggregated at a higher hierarchical level, such as using confidential computing (e.g., by decrypting both aggregated results within a secure enclave, performing aggregation on the decrypted results within the secure enclave, and then re-encrypting the results of the aggregation before sending the results outside of the secure enclave).

According to certain embodiments, cryptographic techniques used for a multi-level data aggregation process may be centrally selected and/or orchestrated, such as by an aggregator device, one of the endpoints, or another centralized component. For example, the centralized component may invoke generic cryptographic functionality provided by the cryptographic agility system described herein (e.g., a generic cryptography module may be located on the same device as the centralized component or may be otherwise in communication with the centralized component) in order to dynamically select one or more cryptographic techniques for use in a privacy-preserving data aggregation process involving a plurality of endpoints and one or more aggregator devices, such as providing contextual information related to the data aggregation process to the cryptographic agility system. In some cases, the endpoints (and, in some embodiments, one or more aggregator device(s)) may transmit local contextual information to the centralized component (e.g., securely, such as in encrypted form), and the centralized component may use the contextual information received from the endpoints to provide contextual information to the cryptographic agility system, such as based on a lowest common denominator across the contextual information received from the endpoints or some other aggregation of the contextual information received from the endpoints. The cryptographic agility system may then dynamically select one or more cryptographic techniques for use in the multi-level data aggregation process (e.g., based on the contextual information as described herein) and provide information about the selected one or more cryptographic techniques to the centralized component. The centralized component may then distribute at least subsets of the information about the one or more selected cryptographic techniques to the endpoints (and, in some embodiments, to the aggregator device(s)) such that the endpoints can use the selected one or more cryptographic techniques to encrypt local data prior to sending such local data to the aggregator device(s). The endpoints may perform encryption using the selected one or more cryptographic techniques themselves or may interact with one or more other components, such as one or more generic cryptography modules, to perform the encryption. The aggregator device(s) may be provided with instructions (e.g., by the centralized component) indicating whether the aggregator device is to decrypt the received local parameters (e.g., if non-homomorphic encryption is used), to perform aggregation on the encrypted local parameters (e.g., if homomorphic encryption is used), to use a confidential computing component, to decrypt homomorphically-encrypted data within a confidential computing component, and/or the like.

Embodiments of the present disclosure improve upon conventional cryptography techniques for data aggregation processes in which cryptographic algorithms are pre-determined for applications (e.g., at design time), in which a single (e.g., predetermined) type of cryptography is used for an entire multi-level data aggregation process, and in which the aggregator device(s) are given access to the unencrypted data, by providing for the dynamic selection of and transitioning between multiple privacy-preserving cryptographic techniques that are tailored for the operations to be performed and for the devices and networks involved, and that may not be natively supported by the applications performing the data aggregation processes. For example, by selecting and securely switching between targeted homomorphic encryption algorithms and/or configurations and/or confidential computing techniques based on the operations to be performed and based on network and/or device and resource constraints of different devices and/or networks, techniques described herein improve the functioning of devices and networks on which cryptographic operations are performed by ensuring that cryptographic operations do not burden devices or networks beyond their capacity or capabilities while preserving the privacy of local data, such as allowing each aggregator device to perform required operations without being granted access to the underlying data. As such, the aggregator device(s) do not need to be trusted with data access, and can be located in an untrusted networking environment (e.g., the Internet or a public cloud environment). Additionally, in the case of homomorphic encryption, the aggregator device(s) do not need to decrypt the data before performing aggregation functions, thereby reducing computing resource utilization at the aggregator device(s) and improving the functioning of the computing system(s). Furthermore, embodiments of the present disclosure improve information security by ensuring that the most secure and updated cryptographic techniques that are consistent with required operations and with device and network constraints may be utilized by an application, even if such techniques were not available at the time the application was developed. Additionally, by utilizing confidential computing environments to perform computations when possible (e.g., decrypting homomorphically-encrypted results of earlier aggregation within a secure enclave) and/or to translate between cryptographic techniques, embodiments of the present disclosure allow for dynamic utilization of multiple cryptographic techniques in association with a single data aggregation process while preserving the privacy of the underlying data even during decryption and re-encryption.

Additionally, techniques described herein may facilitate an organization's use of uniform policy configuration (e.g., a suite of coordinated policies), such as to orchestrate cryptographic usage across many endpoints (e.g., involved in a data aggregation process). Embodiments of the present disclosure may also be used to facilitate migration to new cryptographic techniques at scale and/or to remove deprecated cryptographic techniques from use in a centralized and coordinated manner.

FIG. 1 is an illustration 100 of example computing components related to cryptographic agility for multi-level privacy-preserving data aggregation, according to embodiments of the present disclosure.

An example data aggregation process involves a federated learning process in which multiple endpoints, such as edge devices 112, 122, 132, and 142 in separate networking environments 110, 120, 130, and 140, send local parameters 116, 126, 136, and 146 to aggregator device 140 for aggregation, and aggregator device 140 sends results of aggregation to aggregator device 160 for higher-level aggregation (e.g., which may include data received from one or more additional endpoints that are not shown). Aggregator device 160 sends a global model 158 and/or a global model 168 produced as a result of the aggregation process back to aggregator device 140, which sends the global model(s) back to the endpoints. It is noted that federated learning does not necessarily involve the creation of a global machine learning model and could also involve the creation of global learned parameters or determinations that are sent back to the endpoints. As such, the term model as used herein is not intended to limit federated learning processes to the creation of machine learning models. Furthermore, other types of data aggregation processes may also be performed with techniques described herein.

Networking environments 110, 120, 130, and 140 may be separate networks, such as data centers (e.g., physical data centers or software defined data centers), cloud environments, local area networks (LANs), and/or the like. In certain embodiments, networking environments 110, 120, 130, and 140 are private networking environments that implement security mechanisms (e.g., firewalls) to prevent unauthorized access. In one particular example, networking environments 110, 120, 130, and 140 are satellite networks and edge devices 112, 122, 132, and 142 are satellite edge nodes. Edge devices 112, 122, and 132 represent physical or virtual devices that provide entry points into networking environments 110, 120, and 130. For example, in some embodiments, communications to and from networking environment 110 are received and/or transmitted via edge device 112, communications to and from networking environment 120 are received and/or transmitted via edge device 122, communications to and from networking environment 130 are received and/or transmitted via edge device 132, and communications to and from networking environment 140 are received and/or transmitted via edge device 142. Edge devices 112, 122, 132, and 142 communicate with an aggregator device 140 via a network (not shown), which may be any sort of connection over which data may be transmitted. In certain embodiments, the network is a wide area network (WAN) such as the Internet. Aggregator device 140 also communicates with another aggregator device 160 via the same or a different network.

Aggregator devices 140 and 160 generally represent physical or virtual devices that perform aggregation functionality for a federated learning process. Aggregator devices 140 and/or 160 may be located, for example, in public networking environments, such as public clouds, or in private network environments. In one example, aggregator device 140 and/or 160 is a cloud service. In other examples, aggregator device 140 and/or 160 may be located in one of networking environments 110, 120, 130, or 140, and/or may be located in one or more different private or public networking environments. In a particular example, aggregator device 140 is a satellite component located on a satellite network while aggregator device 160 is not located on a satellite network, such as being a ground station. Satellite components may have greater resource and/or hardware constraints than non-satellite components such as ground stations, and so differing cryptographic techniques may be best suited to protecting the data while it is transmitted between and operated on by the different components.

Aggregator device 160 includes a confidential computing component 154. For example, confidential computing component 154 may be a secure processor enclave of a processing device. Confidential computing component 154 generally represents a hardware-backed secure environment that shields code and data from observation or modification by any components outside of the secure environment, thus reducing the burden of trust on a computer's operating system or hypervisor while allowing computations to be performed on the data within the secure environment. Confidential computing component 154 may, for example, provide such a secure environment through a partitioning process in which the central processing unit (CPU) places hardware checks on the memory allocated to each component such as a virtual machine (VM) on aggregator device 160 and ensures these boundaries are not crossed, or through a memory encryption process in which the CPU automatically encrypts VM memory with different keys for different VMs. Confidential computing component 154 may also provide such a secure environment through a combination of these techniques, and/or through one or more other techniques.

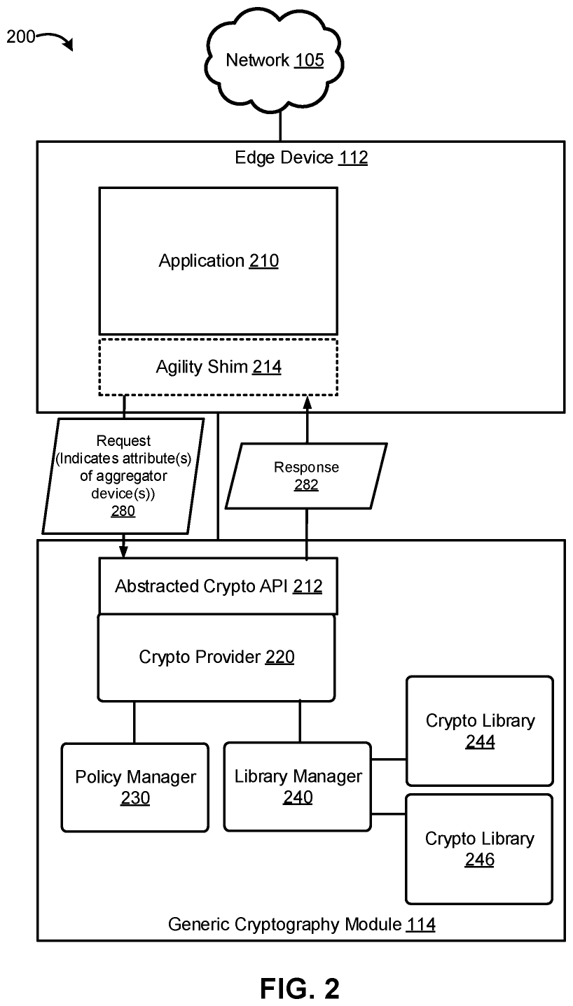

Edge devices 112, 122, 132, and 142 communicate with generic cryptography modules 114, 124, 134, and 144 in order to perform cryptographic functionality related to the federated learning process. As described in more detail below with respect to FIG. 2, generic cryptography modules 114, 124, 134, and 136 may be physical or virtual computing devices, such as server computers or virtual computing instances (VCIs), on which components of a cryptographic agility system reside. For example, generic cryptography modules 114, 124, 134, and 144 generally perform operations related to dynamically selecting cryptographic techniques (e.g., based on contextual information related to requests for cryptographic operations), performing the requested cryptographic operations according to the selected techniques, and providing results of the operations to the requesting components. It is noted that while generic cryptography modules 114, 124, 134, and 144 are shown as separate devices from edge devices 112, 122, 132, and 142 in networking environments 110, 120, 130, and 140 these generic cryptography modules may alternatively be implemented on the same devices as edge devices 112, 122, 132, and/or 142 (e.g., as separate software components).

In an example, edge devices 112, 122, 132, and/or 142 send requests to generic cryptography modules 114, 124, 134, and/or 144 to encrypt local data (e.g., local model parameters determined through a local model training process based on local training data), such as indicating that the requests relate to a multi-level privacy-preserving data aggregation process, indicating one or more attributes of aggregator device 140 and/or aggregator device 160, indicating one or more types of mathematical operations to be performed by aggregator device 140 and/or aggregator device 160, and/or the like in the request. Generic cryptography modules 114, 124, 134, and/or 144 dynamically select one or more cryptographic techniques such as involving one or more homomorphic encryption algorithms and/or one or more confidential computing techniques based on attributes associated with the requests, such as the operations to be performed, other computing resource and/or capability constraints, policy considerations, and/or the like. In some embodiments, generic cryptography modules 114, 124, 134, and/or 144 communicate with each other and/or with one or more additional components, such as via secure channels established between them, to coordinate aspects of the one or more selected encryption techniques. For instance, generic cryptography modules 114, 124, 134, and/or 144 may determine a multi-technique encryption scheme in which a first cryptographic technique (Technique A) is selected for transmitting data from edge devices 112 and 132 to aggregator device 140, a second cryptographic technique (Technique B) is selected for transmitting data from edge device 122 and 142 to aggregator device 140, and a third cryptographic technique (e.g., a confidential computing technique) is selected for protecting data while being aggregated at aggregator device 160. While not shown, one or more transmission ciphers may alternatively or additionally be selected. For example, the dynamic selection of cryptographic techniques (e.g., Technique A, Technique B, etc) may be based on various types of contextual information related to the data aggregation process, such as device and/or resource constraints of each edge device, device and/or resource constraints of each aggregator device, and/or the like. In an example, edge devices 112 and 132 are determined to share similar contextual information, and so the same cryptographic technique (Technique A) is selected for both of these edge devices (e.g., thus treating edge devices 112 and 132 as a group). Similarly, edge devices 122 and 142 are determined to share similar contextual information, and so the same cryptographic technique (Technique b) is selected for both of these edge devices (e.g., thus treating edge devices 122 and 142 as a group).

In an example, generic cryptography modules 114 and 134 securely share an encryption key that is used at both generic cryptography modules 114 and 134 to encrypt local data using Technique A and generic cryptography modules 124 and 144 securely share an encryption key that is used at both generic cryptography modules 124 and 144 to encrypt local data using Technique B. In another example, generic cryptography modules 114, 124, 134, and/or 144 coordinate a multi-key homomorphic encryption scheme with one another so that a key does not need to be shared between generic cryptography modules 114, 124, 134, and/or 144. In some embodiments, generic cryptography modules 114, 124, 134, and/or 144 coordinate with a generic cryptography module associated with aggregator device 140 and/or aggregator device 160 as well, such as indicating selected encryption technique(s). Generic cryptography module 114, 124, 134, and/or 134 also send one or more encryption keys to confidential computing component 154, such as via a secure channel, for use in decrypting results of aggregation performed by aggregator device 140 within confidential computing component 154 for aggregation.

After dynamically selecting encryption techniques, generic cryptography modules 114, 124, 134, and 144 may encrypt the respective local data using the selected technique(s) and return the respective encrypted local data to edge devices 112, 122, 132, and 142. In alternative embodiments, generic cryptography modules 114, 124, 134, and 144 rather than performing encryption themselves, may provide information to one or more other components, such as edge devices 112, 122, 132, and 142 and/or other encryption components, to perform the selected encryption technique(s).

If a selected technique involves homomorphic encryption, then the encrypted data can be sent to an aggregator device without any encryption key being provided to the aggregator device, and the aggregator device can perform computations on the encrypted data without decryption.

It is noted that while certain embodiments involve individual edge devices communicating with separate generic cryptography modules in order to dynamically select cryptographic techniques, other embodiments involve a centralized component selecting one or more cryptographic techniques for use by a variety of endpoints involved in a multi-level data aggregation process and sharing information about the selected cryptographic technique(s) with individual endpoints as needed so that the selected cryptographic techniques can be utilized.

Edge devices 112 and 132 send the encrypted local parameters 116 and 136 (encrypted using Technique A, which may be a first homomorphic encryption technique that is selected based on context information) to aggregator device 140, which performs aggregation on local parameters 116 and 136 at step 145. Edge devices 122 and 142 send the encrypted local parameters 126 and 146 (encrypted using Technique B, which may be a second homomorphic encryption technique that is selected based on context information) to aggregator device 140, which performs aggregation on local parameters 126 and 146 at step 147. For example, in the case of homomorphic encryption, at steps 145 and 147 aggregator device 140 may perform one or more mathematical operations, such as addition, subtraction, division, and/or multiplication in order to aggregate encrypted local parameters 116 and 136 and to aggregate encrypted local parameters 126 and 146 without decrypting any of local parameters 116, 126, 136, or 146. In one example, aggregator device 140 calculates an average of encrypted local parameters 116 and 136 at step 145 by adding encrypted local parameters 116 and 136 and dividing the sum by the total number of edge devices from which data was received (e.g., which is two in the depicted example), and performs a similar average calculation for local parameters 126 and 146 at step 147.

The result of aggregation performed by aggregator device 140 at step 145 comprises aggregated parameters 142, which remain encrypted with Technique A. The result of aggregation performed by aggregator device 140 at step 147 comprises aggregated parameters 144, which remain encrypted with Technique B. Aggregated parameters 142 and 144 in encrypted form, are then sent to aggregator device 160.

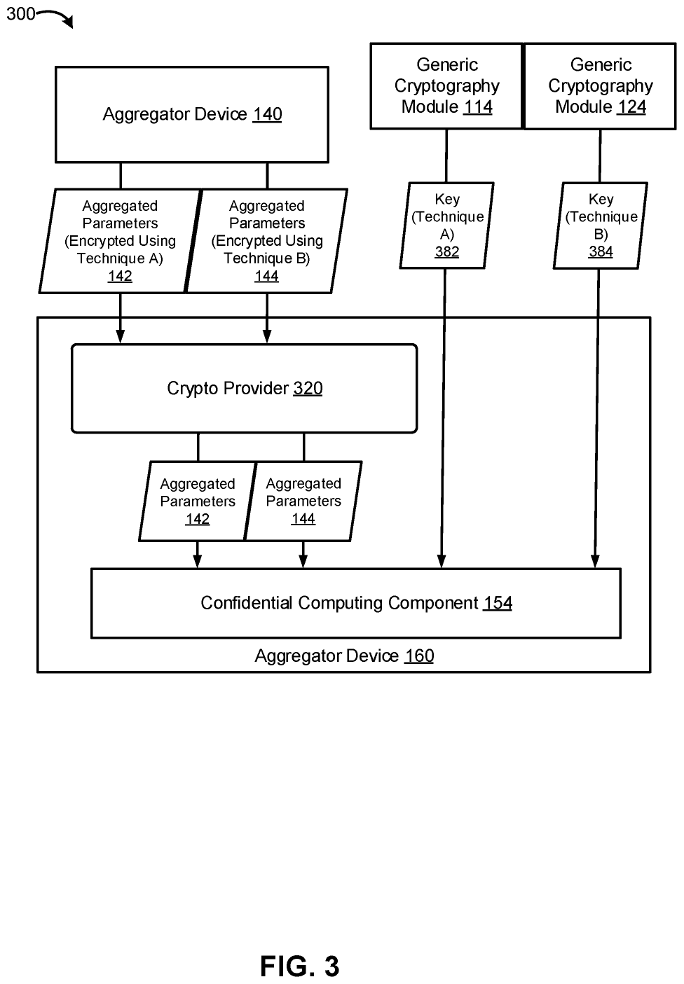

As described in more detail below with respect to FIG. 3, confidential computing component 154 may have received, via a secure channel, encryption keys for use in decrypting aggregated parameters 142 and 144. For example, generic cryptography module 114 and/or 134 may have sent confidential computing component 154 the key used to encrypt local parameters 116 and 134 using Technique A and generic cryptography module 124 and/or 144 may have sent confidential computing component 154 the key used to encrypt local parameters 126 and 144 using Technique B. In one embodiment, aggregated parameters 142 and 144 are decrypted within confidential computing component 154 using the encryption keys received by confidential computing component 154 (the decrypted aggregated parameters will, as a result of the homomorphic encryption techniques used, be equivalent to what the results would have been of applying the aggregation computations that were applied at steps 145 and 147 directly to the unencrypted local parameters). The decrypted aggregated parameters 142 and 144 are then aggregated with one another and/or with data received from one or more other endpoints within confidential computing component 154. The results of performing such aggregation within confidential computing component 154 are then re-encrypted within confidential computing component 154. In one example, the results of aggregation within confidential computing component 154, which may be a global model or global model parameters, are encrypted using Technique A to produce global model 158 and are also re-encrypted using Technique B to produce global model 168.

Aggregator device 160 sends global model 158 (encrypted using Technique A) and global model 168 (encrypted using Technique B) to aggregator device 140, which sends global model 158 to edge devices 112 and 134 and sends global model 168 to edge devices 122 and 142. Global model 158 can then be decrypted using the key associated with Technique A and global model 168 can then be decrypted using the key associated with Technique B (e.g., through communication with respective generic cryptography modules) in order to produce the final unencrypted global model at the edge devices. Alternatively, the global model may be sent back to the edge devices from aggregator device 160 (e.g., either directly or via aggregator device 140) without being re-encrypted using Techniques A and B, such as being encrypted using a different, non-homomorphic encryption technique with confidential computing component 154 sending a key for use in decrypting the global model to the edge devices via a secure channel.

It is noted that in many embodiments the number of participating endpoints (e.g., edge devices) will be larger than four. Furthermore, participating endpoints need not be edge devices, and edge devices are included as an example. Additionally, aggregation is not limited to averaging, and other types of aggregation computations may alternatively be performed. The local parameters that are aggregated to produce global parameters may include, for example, gradients, weights, hyperparameters, and/or the like.

The results of computations performed by aggregator devices 140 and 160 on encrypted local parameters will remain encrypted on aggregator devices 140 and 160 except within confidential computing component 154, such that aggregator devices 140 and 160 will not have access to the unencrypted local parameters or the unencrypted global parameters.

Thus, edge devices 112, 122, 132, and 142 are provided with a global model that benefits from the local training performed at all endpoints without being biased by peculiar attributes of local training data from any individual endpoint. Furthermore, the privacy of the local data is preserved, as aggregator devices 140 and 160 are never granted access to the unencrypted local data or the unencrypted global data outside of confidential computing component 154, and the unencrypted local data is never shared between different endpoints. Additionally, computing resource constraints and capabilities of the computing devices and networks are respected through the dynamic selection of and translation between cryptographic techniques based on such constraints and capabilities, such as selecting one or more homomorphic encryption techniques and/or confidential computing that are consistent with available hardware, that support the particular mathematical operations that are to be performed by aggregator devices 140 and 160 (and that comply with one or more additional policies), and/or that also are well-suited to the devices and networks involved in the multi-level data aggregation process.

In many cases, such as the satellite/ground station example described above, lower levels in a hierarchy of a multi-level data aggregation process, such as satellite components, have greater resource and/or hardware constraints (e.g., lacking confidential computing components and/or having fewer available processing, memory, and/or network resources) while higher levels in the hierarchy have fewer resource and/or hardware constraints (e.g., having confidential computing components and/or having larger amounts of available processing, memory, and/or network resources). For example, once a hierarchical level is reached at which a confidential computing component is available, it is likely that subsequent, higher hierarchical levels will also have confidential computing components available. However, in some embodiments, a confidential computing component may be used to translate between two different cryptographic techniques in a privacy-preserving manner, such as decrypting data using a first cryptographic technique and then re-encrypting the data using a second cryptographic technique within the confidential computing component.

According to certain embodiments, the data path by which local parameters are sent up the hierarchy for aggregation and by which the results of aggregation (e.g., the global model) are sent back down the hierarchy to the edge devices is selected so as to preserve bandwidth at each layer of communication. For example, devices chosen to be aggregator devices and/or otherwise paths by which data is to be transmitted up and down a multi-level aggregation scheme are dynamically selected based on resource constraints, such as available bandwidth, congestion, throughput, and/or other resource-related constraints, thereby optimizing the utilization of available network, processing, and/or memory resources.

It is noted that while certain embodiments are described in which aggregator devices perform aggregation on encrypted data from endpoints (or on decrypted data within confidential computing components) and send results of the aggregation back to the endpoints, other embodiments may involve the aggregation devices acting as middle boxes that perform aggregation on data from endpoints and then send results of the aggregation to one or more different endpoints (e.g., different than the endpoints from which the encrypted data was received). For example, the one or more different endpoints may be provided one or more decryption keys (e.g., used to generate the encrypted data) by the one or more endpoints, and the one or more different endpoints may use the one or more decryption keys to decrypt the results of the aggregation received from the aggregation devices.

The arrangement depicted and described with respect to FIG. 1 is included as an example in which privacy-preserving cryptographic agility may be performed, and many other use cases are possible. A data aggregation process may involve more or fewer hierarchical levels of data aggregation than those shown and described, and more or fewer cryptographic techniques may be selected and/or switched between.

FIG. 2 is an illustration 200 of an example related to dynamic cryptographic technique selection for multi-level privacy-preserving data aggregation, according to embodiments of the present disclosure. Illustration 200 includes network 105, edge device 112, and generic cryptography module 114 of FIG. 1.

Edge device 112 may be a physical or virtual computing device, such as a server computer, that runs an application 210. In some embodiments, edge device 112 may be a virtual computing instance (VCI), such as a virtual machine (VM) or container that runs on a physical host computer that includes one or more processors and/or memory devices. It is noted that edge device 112 is included as an example computing device on which application 210 and/or associated components may be located, and other types of devices may also be used.

Application 210 generally represents a software application that requires cryptographic functionality. For example, application 210 may rely on cryptographic functionality to encrypt data that it transmits over a network (e.g., network 105), such as to aggregator device 140 of FIG. 1, such as within a data aggregation process in which multiple aggregator devices are involved. In one example, application 210 performs operations related to federated learning, such as sending local model parameters (e.g., which may have been generated at edge device 112 and/or one or more other devices involved in a local model training process based on local training data) to one or more aggregator devices for aggregation with local parameters from other edge devices. While conventional techniques generally involve direct integration of cryptographic libraries with applications that rely on cryptographic functionality, such as for transmitting data associated with a federated learning process, techniques described herein involve abstracting cryptographic functionality away from such applications. As such, an abstracted crypto application programming interface (API) 212 is provided as a means of interaction between application 210 and a separate cryptographic agility system. Application 210 may call generic cryptographic functions of abstracted crypto API 212 in order to invoke particular cryptographic functionality, and the cryptographic agility system may select cryptographic techniques and perform cryptographic operations in response to the function invocations based on contextual information (e.g., including the hardware capabilities of one or more devices, types of mathematical operations to be performed, resource constraints, and/or the like). Thus, application 210 may be merely a consumer of cryptography provided by the separate cryptographic agility system, rather than implementing cryptography itself.

The cryptographic agility system includes abstracted crypto API 212 and, in certain embodiments, an optional agility shim 214, as well as crypto provider 220, policy manager 230, and library manager 240. In some embodiments, while depicted as separate components, the functionality associated with agility shim 214, abstracted crypto API 212, policy manager 230, and/or library manager 240 may be part of crypto provider 220 and/or may be implemented by more or fewer components. In certain embodiments, abstracted crypto API 212 and/or agility shim 214 are part of application 210. In alternative embodiments, abstracted crypto API 212 and/or agility shim 214 may be located on a separate device from edge device 112, such as on the same device as generic cryptography module 114 or a different computing device.

Agility shim 214 generally intercepts API calls (e.g., calls to functions of abstracted crypto API 212) and redirects them to crypto provider 220 via abstracted crypto API 212. Shims generally allow new software components to be integrated with existing software components by intercepting, modifying, and/or redirecting communications. As such, agility shim 214 allows application 210 to interact with crypto provider 220 even though application 210 may have no knowledge of crypto provider 220. For instance, application 210 may make generic function cryptographic function calls (e.g., requesting that an item of data be encrypted), and these generic function calls may be intercepted by agility shim 214 (e.g., if such a shim is needed) and redirected to crypto provider 220 via the abstracted crypto API 212 exposed by crypto provider 220.

It is noted that while embodiments of the present disclosure are depicted on edge device 112 and generic cryptography module 114, alternative embodiments may involve various components being located on more or fewer computing devices. In some cases, aspects of the cryptographic agility system may be implemented in a distributed fashion across a plurality of computing devices. In certain embodiments, said components may be located on a single computing device.

In certain embodiments, generic cryptography module 114 comprises a physical or virtual computing device, such as a server computer, on which components of the cryptographic agility system, such as crypto provider 220, policy manager 230, and/or library manager 240, reside. For example, generic cryptography module 214 may represent a VCI or a physical computing device. Generic cryptography module 214 may be connected to network 105 and/or one or more additional networks (e.g., networking environment 110 of FIG. 1).

Crypto provider 220 generally performs operations related to dynamically selecting cryptographic techniques (e.g., based on contextual information related to requests for cryptographic operations, such as whether specialized hardware is available, the types of mathematical operations to be performed at one or more aggregator devices in a federated learning process, and/or the like), performing the requested cryptographic operation(s) according to the selected technique(s), and providing results of the operation(s) to the requesting components. Cryptographic techniques may include the use of cryptographic algorithms (e.g., included in one or more libraries), and/or specific configurations of cryptographic algorithms, as described herein. In some embodiments, the cryptographic agility system is located on the same device as application 210, while in other embodiments the cryptographic agility system is located on a separate device, such as on a server that is accessible over a network.

In certain aspects, crypto provider 220 has two major subsystems, policy manager 230 and library manager 240. Policy manager 230 performs operations related to cryptographic policies, such as receiving policies defined by users and storing information related to the policies, such as in a policy table. According to certain embodiments, a centralized policy control server may orchestrate policy across a plurality of generic cryptography modules, such as including generic cryptography module 114. For example, an administrator or other user may configure one or more policies at a centralized policy control server, and the one or more policies may be distributed to a plurality of generic cryptography modules for storage by corresponding policy managers, such as including policy manager 230. In an example, a policy is based on one or more of an organizational context and a user context related to a cryptographic request. In some embodiments, a policy may map a cryptographic request and its associated context information to attributes of cryptographic techniques, such as a particular cryptographic technique in a particular cryptographic library and a particular set of parameters for configuring the particular cryptographic technique.

Organizational context may involve geographic region (e.g., country, state, city and/or other region), industry mandates (e.g., security requirements of a particular industry, such as related to storage and transmission of medical records), government mandates (e.g., laws and regulations imposed by governmental entities, such as including security requirements), and the like. For instance, a policy may indicate that if a cryptographic request is received in relation to a device associated with a particular geographic region, associated with a particular industry, and/or within the jurisdiction of a particular governmental entity, then crypto provider 220 must select a cryptographic technique that meets one or more conditions (e.g., having a particular security rating, being configured to protect against particular types of threats, and/or involving confidential computing or homomorphic encryption) in order to comply with relevant laws, regulations, preferences, or mandates.

User context may involve user identity (e.g., a user identifier or category, which may be associated with particular privileges), data characteristics (e.g., whether the data is sensitive, classified, or the like), application characteristics (e.g., whether the application is a business application, an entertainment application, or the like), platform characteristics (e.g., details of an operating system), device characteristics (e.g., hardware configurations and capabilities of the device, resource availability information, and the like), device location (e.g., geographic location information, such as based on a satellite positioning system associated with the device), networking environment (e.g., a type of network to which the device is connected, such as a satellite or land-based network connection), and/or the like. For example, a policy may indicate that if a cryptographic request is received with respect to a particular category of user (e.g., administrators, general users, or the like), relating to a particular type of data (e.g., tagged as sensitive or meeting characteristics associated with sensitivity, such as being financial or medical data, or being associated with privacy-preserving data aggregation), associated with a particular application or type of application, associated with a particular platform (e.g., operating system), with respect to a device with particular capabilities or other attributes (e.g., having a certain amount of processing or memory resources, having an accelerator, having one or more particular types of processors, and/or the like), with respect to a device in a particular location (e.g., geographic location) or type of networking environment (e.g., cellular network, satellite-based network, land network, or the like), and/or that is to be transmitted to a device having one or more particular characteristics (e.g., being untrusted, being located in a public networking environment, being located in a particular geographic region, having specialized hardware, and/or the like), then crypto provider 220 should select a cryptographic technique that meets one or more conditions.

In one example, a policy indicates that if a request relates to encrypting data that is to be transmitted to a device that is untrusted for one or more reasons for computation to be performed on the data, then a confidential computing or homomorphic encryption technique should be selected. In certain embodiments, a policy may specify that, unless otherwise required (e.g., because of another policy, such as related to security level), when homomorphic encryption is used, a homomorphic encryption technique that supports the required mathematical operations while having the lowest resource utilization requirements of all such homomorphic encryption techniques is to be selected. In certain embodiments, a policy may simply specify an allowed list of ciphers or an allowed list of cryptographic technique characteristics. In some cases, a policy may relate to resource constraints (e.g., based on available processing, memory, network, physical storage, accelerator, entropy source, or battery resources), such as specifying that cryptographic techniques must be selected based on resource availability (e.g., how much of a device's processing and/or memory resources are currently utilized, how much latency is present on a network, and the like) and/or capabilities (e.g., whether a device is associated with an accelerator) associated with devices and/or networks, while in other embodiments crypto provider 220 selects cryptographic techniques based on resource constraints and/or supported mathematical operations independently of policy manager 230 (e.g., for all applicable cryptographic requests regardless of whether any policies are in place). For example, policies may only relate to security levels of cryptographic techniques, such as requiring the use of cryptographic techniques associated with particular security ratings when certain characteristics are indicated in contextual information related to a cryptographic request, and resource constraints may be considered separately from policies. In one example, once all cryptographic techniques meeting the security requirements, hardware requirements, and/or mathematical operation requirements for a cryptographic request are identified (e.g., based on policies or otherwise), a cryptographic technique is selected from these compliant cryptographic techniques based on resource constraints.

It is noted that resource constraints and/or capabilities may include a variety of different types of information, such as processor availability and/or capabilities (e.g., clock rate, number of cores, instruction-level features such as single instruction multiple data (SIMD) instructions, types of processors, inclusion of secure enclaves, and/or the like) memory availability and/or capabilities (e.g., memory size and performance), accelerator capabilities (e.g., hardware-based cryptographic accelerator units available for use with the device), battery capabilities (e.g., lifetime, current power remaining, and/or the like), information about entropy (e.g., how much entropy is available for random numbers, the source of entropy such as an OS, hardware module, CPU platform, or the like, whether available entropy sources are federal information processing standards (FIPS) compliant, and/or the like), network connectivity information (e.g., bandwidth, loss metrics for the channel, congestion, latency, and/or the like), information about the device's physical exposure to potential side-channel attacks and/or ease of side channel analysis, and/or the like. Thus, any of these types of data points may be gathered from devices and/or networks, and may be used in selecting cryptographic techniques (e.g., based on policies and/or tags related to these data points associated with cryptographic techniques).

A policy table may stores information related to policies. In some embodiments, a policy table maps various contextual conditions (e.g., relating to organizational context and/or user context) to cryptographic technique characteristics (e.g., whether techniques are privacy-preserving, homomorphic, involve confidential computing, require specialized hardware, support certain mathematical operations, have certain security ratings, protect against certain threats, have certain resource utilization ratings, and the like). For example, a contextual condition may be the use of a certain type of application, the requirement that privacy be preserved during computation, the requirement of certain mathematical operations to be performed on encrypted data, a certain type of data, or a particular geographic location. A cryptographic technique characteristic may be, for example, whether the cryptographic technique is homomorphic, whether the cryptographic technique involves confidential computing and/or requires certain specialized hardware, supported mathematical operations, a security rating (e.g., 0-10), whether the cryptographic technique is quantum-safe, what level of resource requirements the cryptographic technique has for a particular type of resource (e.g., memory, processor, or network resources), or the like. Thus, when cryptographic requests are received, a policy table may be used to determine whether the cryptographic requests are associated with any characteristics included in policies and, if so, what cryptographic technique characteristics are required by the policies for servicing the requests.

Library manager 240 generally manages cryptographic libraries containing cryptographic algorithms and/or techniques. For example crypto libraries 244 and 246 each include various cryptographic algorithms and/or techniques, each of which may include configurable parameters, such as key size, choice of elliptic curve, algorithm sizing parameters, and the like, and characteristics such as ciphertext size. For instance, cryptographic techniques (e.g., algorithms and/or specific configurations of algorithms, and/or confidential computing techniques) may be registered with library manager 240 along with information indicating characteristics of the cryptographic techniques. Examples of algorithms include the Paillier cryptosystem, the Boneh-Goh-Nissim cryptosystem, the Rivest-Shamir-Adleman (RSA) cryptosystem, the Gentry cryptosystem(s), the Brakerski-Gentry-Vaikuntanathan (BGV) cryptosystem(s), the Cheon, Kim, Kim and Song (CKKS) cyrptosystem(s), the Clear and McGoldrick multi-key homomorphic cryptosystem, data encryption standard (DES), triple DES, advanced encryption standard (AES), Diffie-Hellman (DH) encryption, Elliptic Curve DH (ECDH) encryption, digital signatures such as Digital Signature Algorithm (DSA) and Elliptic Curve DSA (ECDSA), cryptographic hash functions such as Secure Hash Algorithm 2 or 3 (SHA-2 or SHA-3), and others. There are many other types of encryption algorithms, including homomorphic and non-homomorphic encryption algorithms, and the algorithms listed herein are included as examples. Some algorithms may, for example, involve symmetric key encryption or asymmetric key encryption, digital signatures or cryptographic hash functions, and/or the like. A configuration of an algorithm may include values for one or more configurable parameters of the algorithm, such as key size, size of lattice, which elliptic curve is utilized, number of bits of security, whether accelerators are used, ciphertext size, and/or the like. Cryptographic techniques may also involve confidential computing techniques, which may rely on the use of specialized hardware, such as Intel® Software Guard Extensions (SGX), Project Amber, Intel® Trust Domain Extensions (TDX), Arm® TrustZone®, and/or the like. A characteristic of a cryptographic technique may be, for example, whether the cryptographic technique is privacy-preserving, whether the cryptographic technique involves confidential computing, whether the cryptographic technique is homomorphic, what types of specialized hardware are required for the cryptographic technique, supported mathematical operations, whether the technique is Turing complete (e.g., supports all types of mathematical operations, such as a fully homomorphic encryption scheme), a security rating, a resource requirement rating, whether the technique requires an accelerator, whether the technique is quantum-safe, or the like. A cryptographic technique may include more than one cryptographic algorithm and/or configuration. In an example, each cryptographic technique is tagged (e.g., by an administrator) based on characteristics of the technique, such as with an indication of whether the cryptographic technique is privacy-preserving, whether the cryptographic technique is homomorphic, what types of specialized hardware are required for the cryptographic technique, an indication of supported mathematical operations, a security rating, an indication of threats protected against by the technique, indications of the resource requirements of the technique, and/or the like.

Information related to cryptographic techniques registered with library manager 240 may be stored in an available algorithm/configuration table. For instance, an available algorithm/configuration table may store identifying information of each available cryptographic technique (e.g., an identifier of a library, an identifier of an algorithm or technique in the library, and/or one or more configuration values for the algorithm) associated with tags indicating characteristics of the technique. It is noted that policies and tags are examples of how cryptographic techniques may be associated with indications of characteristics, and alternative implementations are possible. For instance, rather than associating individual cryptographic techniques with tags, alternative embodiments may involve associating higher-level types of cryptographic techniques with tags, and associating individual cryptographic techniques with indications of types. For example, a higher-level type of cryptographic technique may be “homomorphic encryption algorithms configured to support addition.” Thus, if tags are associated with this type (e.g., including supported mathematical operations, security ratings, recourse requirement ratings, and the like), any specific cryptographic techniques of this type (being homomorphic encryption algorithms, and being configured to support addition) will be considered to be associated with these tags. In another example, fuzzy logic and/or machine learning techniques may be employed, such as based on historical cryptographic data indicating which cryptographic techniques were utilized for cryptographic requests having particular characteristics. In some embodiments, tags may be associated with specific configurations of cryptographic algorithms, such as assigning a security rating to a particular set of configuration parameters for a particular cryptographic algorithm or type of algorithm.

Tags associated with cryptographic techniques may be updated as appropriate over time, such as based on input from a user (e.g., an administrator, security operations professional, and/or the like). For example, a user may provide input upgrading or downgrading a security rating for a particular cryptographic technique, type of cryptographic technique, or configuration of a cryptographic technique (e.g., from 10 out of 10 to 8 out of 10), such as based on changed understandings of vulnerabilities or strengths of particular techniques.

By allowing cryptographic techniques and libraries, including new homomorphic encryption techniques that may become available due to the ongoing research into such techniques, to be registered and deregistered with library manager 240 on an ongoing basis, and to be associated with metadata such as tags that can be dynamically updated, embodiments of the present disclosure allow the pool of possible cryptographic techniques to be continuously updated to meet new conditions and threats. For example, as new libraries and/or techniques are developed, these libraries and/or techniques may be added to library manager 240, and such cryptographic techniques may be used by crypto provider 220 in servicing requests from application 210 without application 210 having any awareness of the new libraries and/or techniques. Similarly, by managing policies and libraries separately, policies may be defined in an abstract manner (e.g., based on characteristics of requests and cryptographic techniques) such that policies may be satisfied through the selection of new cryptographic techniques that were not known at the time of policy creation.

In one particular example, a new cryptographic technique is tagged as being fully homomorphic (e.g., Turing complete), meaning that the cryptographic technique was developed to support all types of mathematical operations in a homomorphic manner. For instance, the new cryptographic technique may have a high security rating (e.g., 10 out of 10) as well as high resource requirements. The new cryptographic technique is registered with library manager 240, and information about the new cryptographic technique and its characteristics is stored in an available algorithm/configuration table. Thus, the new cryptographic technique is available to be selected by crypto provider 220 for servicing cryptographic requests from application 210.

Continuing with the example, a policy states that cryptographic requests relating to data that is to be sent to an aggregator device for aggregation as part of a federated learning process is to be encrypted using a fully homomorphic technique if such a technique is available, unless device and/or network resource constraints prohibit the use of such a technique. Thus, when application 210 submits a cryptographic request 280 (e.g., via a call to a generic cryptographic function provided by abstracted crypto API 212) to encrypt an item of data that is to be sent to an aggregator device for aggregation as part of a federated learning process, crypto provider 220 determines based on information stored in the policy table that a fully homomorphic cryptographic technique is to be used if possible. Crypto provider 220 determines based on information in the available algorithm/configuration table that the new cryptographic technique is fully homomorphic. Next, crypto provider 220 analyzes resource constraints related to the cryptographic request 280 to determine if the new cryptographic technique can be performed. If crypto provider 220 determines that the device and/or network associated with application 210 can support the new cryptographic technique (e.g., based on available resources), then crypto provider 220 selects the new cryptographic technique for servicing the cryptographic request 280, and provides a response 282 to application 210 (e.g., via agility shim 214) accordingly. However, if crypto provider 220 determines that the device and/or network associated with application 210 cannot support the new cryptographic technique (e.g., based on available resources), then crypto provider 220 selects a different cryptographic technique for servicing the cryptographic request 280, such as a different homomorphic encryption technique that supports the mathematical operations indicated in request 280 and that otherwise complies with the resource constraints of the device and/or network, and provides a response 282 to application 210 (e.g., via agility shim 214) accordingly. In some embodiments, the request indicates that multiple aggregator devices are involved in the aggregation process, and indicates attributes of each aggregator device, such as operations to be performed at each aggregator device and resource constraints of each aggregator device. In such as case, crypto provider 220 may select a different cryptographic technique for each aggregator device, and (as needed) information related to one or more of the selected cryptographic techniques may be sent to a confidential computing component of a cryptographic translator server for use in translating between the selected cryptographic techniques.

In some cases, the response sent from crypto provider 220 to application 210 includes data encrypted using the selected technique. In other cases, the response includes information related to performing the selected technique(s) to encrypt the data, and the encryption is performed on the device from which the request was sent. In still other cases, one or more other components and/or devices may be involved in performing the encryption according to the technique(s) selected by crypto provider 220.

In some cases, more than one cryptographic technique may be selected for servicing a given cryptographic request, even for a single aggregator device. For instance, an item of data may first be encrypted using a first technique (e.g., that satisfies one or more first conditions related to policy and/or resource considerations) and then the encrypted data may be encrypted again using a second technique (e.g., that satisfies one or more second conditions related to policy and/or resource considerations). For example, a dual or multi-encryption scheme such as composite encryption or hybrid encryption may be employed for servicing a single cryptographic request. In some embodiments, one or more homomorphic encryption techniques and one or more confidential computing techniques may be selected to service a single cryptographic request.

There may be cases where there is no available cryptographic technique that complies with all policies, privacy-preservation constraints, device constraints, resource constraints, and operation constraints and so trade-offs may be made (e.g., in accordance with policies and/or logic governing such cases), such as selecting a cryptographic technique that is not fully compliant with one or more of these factors (e.g., if certain factors are non-mandatory), or certain cryptographic requests may be declined as impossible under the circumstances.

FIG. 3 is an illustration 300 of an example related to cryptographic agility for multi-level privacy-preserving data aggregation. Illustration 300 includes aggregator devices 140 and 160, generic cryptography modules 114 and 124, confidential computing component 154, and aggregated parameters 142 and 142 of FIG. 1.

Aggregator device 140 sends aggregated parameters 142 and 144, which may be the result of a first aggregation performed by aggregator device 140 on data from multiple endpoints and that is encrypted using a first cryptographic technique (Technique A) and a second aggregation performed by aggregator device 140 on data from multiple different endpoints and that is encrypted using a second cryptographic technique (Technique B), to aggregator device 160, where aggregated parameters 142 and 144 are received by a crypto provider 320. Crypto provider 320 may be similar to crypto provider 220 of FIG. 2. Crypto provider 320 may determine that a third cryptographic technique (e.g., a confidential computing technique) is to be used to perform further aggregation on aggregated parameters 142 and 144 (e.g., crypto provider 320 may determine this itself or based on communication with one or more other crypto providers, such as associated with generic cryptography module 114 and/or 124). In an example, the first cryptographic technique and the second cryptographic technique were selected based on aggregator device 140 (e.g., according to attributes of aggregator device 140) and the third cryptographic technique is selected based on aggregator device 160 (e.g., according to attributes of aggregator device 160). Aggregated parameters 142 and 144 are then provided to confidential computing component 154 to be decrypted using the first cryptographic technique and the second cryptographic technique and then further aggregated (e.g., with one another and/or with data received from other endpoints). For example, generic cryptography module 114 may have sent a key 382 (e.g., that it used to encrypt aggregated parameters 142, such as corresponding to Technique A) corresponding to the first cryptographic technique to confidential computing component 154 via a secure channel, and key 382 may be used to decrypt aggregated parameters 142 within confidential computing component 154. Similarly, generic cryptography module 124 may have sent a key 384 (e.g., that it used to encrypt aggregated parameters 144, such as corresponding to Technique B) corresponding to the second cryptographic technique to confidential computing component 154 via a secure channel, and key 384 may be used to decrypt aggregated parameters 144 within confidential computing component 154. The unencrypted aggregated parameters may then be aggregated with one another and/or with other data, and then the results of such aggregation may be re-encrypted within confidential computing component 154. For example, the results of the aggregation may be re-encrypted using the first cryptographic technique and the second cryptographic technique, and/or with one or more other cryptographic techniques, and the re-encrypted results may be returned to crypto provider 320, and then provided to aggregator device 140 (and/or to one or more other endpoints, such as to another aggregator device for a higher level of aggregation to be performed).

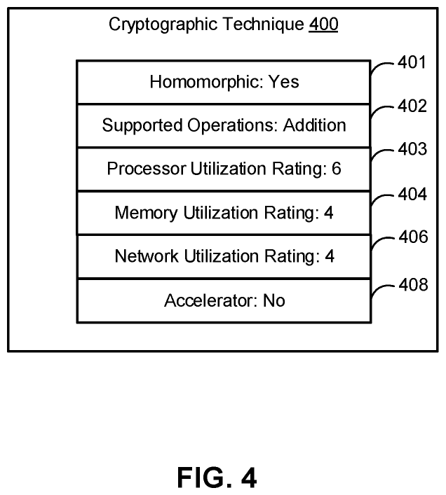

FIG. 4 depicts an example of tagging cryptographic techniques based on attributes, including tagging homomorphic encryption techniques with supported mathematical operations.

A cryptographic technique 400 comprises one or more cryptographic algorithms and/or configurations of algorithms. For instance cryptographic technique 400 may be included in a cryptographic library, and may be registered with library manager 240 of FIG. 2 as an available cryptographic technique for use in a cryptographic agility system.

Tags 401, 402, 403, 404, 406, and 408 are associated with cryptographic technique 400 to indicate characteristics of cryptographic technique 400. For example, these tags may be added by an administrator at the time cryptographic technique 400 is registered with library manager 240 of FIG. 2. While not depicted, cryptographic technique 400 may also be associated with other tags related to, for example, a security level of cryptographic technique 400, threats protected against by cryptographic technique 400, whether cryptographic technique 400 is quantum-safe, and/or the like.

Tags 401, 402, 403, 404, 406, and 408 may be based on a variety of characteristics of cryptographic technique 400, such as the nature of involved cryptographic algorithm(s), key size, size of lattice, which elliptic curve is utilized, number of bits of security, whether accelerators are used, ciphertext size, whether side channel attacks are protected against (e.g., resulting in higher resource usage), and/or the like.

Tag 401 indicates that cryptographic technique 400 is a homomorphic encryption technique.

Tag 402 indicates that cryptographic technique 400 supports the mathematical operation of addition, such as meaning that addition can be performed on data encrypted using cryptographic technique 400 without decryption in order to produce an encrypted result that, when decrypted using cryptographic technique 400, is the same as the result would have been if the addition operation had been performed on the unencrypted data. While not shown, one or more additional tags may indicate how many times each given supported type of mathematical operation can be performed on data encrypted using cryptographic technique 400 (e.g., while still maintaining homomorphic properties).

Tag 403 indicates a processor utilization rating of 6. In an example, processor utilization ratings may range from 0-10, and generally indicate an amount of processing resources required by a cryptographic technique.

Tag 404 indicates a memory utilization rating of 4. In an example, memory utilization ratings may range from 0-10, and generally indicate an amount of memory resources required by a cryptographic technique.

Tag 406 indicates a network utilization rating of 4. In an example, network utilization ratings may range from 0-10, and generally indicate an amount of network resources required by a cryptographic technique.

Tag 408 indicates that an accelerator is not used by cryptographic technique 300.

Tags 401, 402, 403, 404, 406, and 408 are included as examples, and other types of tags may be included. Tags 401, 402, 403, 404, 406, and 408 generally allow a cryptographic agility system to identify which cryptographic techniques are best suited for a given cryptographic request, such as related to a multi-level privacy-preserving data aggregation process, based on various characteristics.

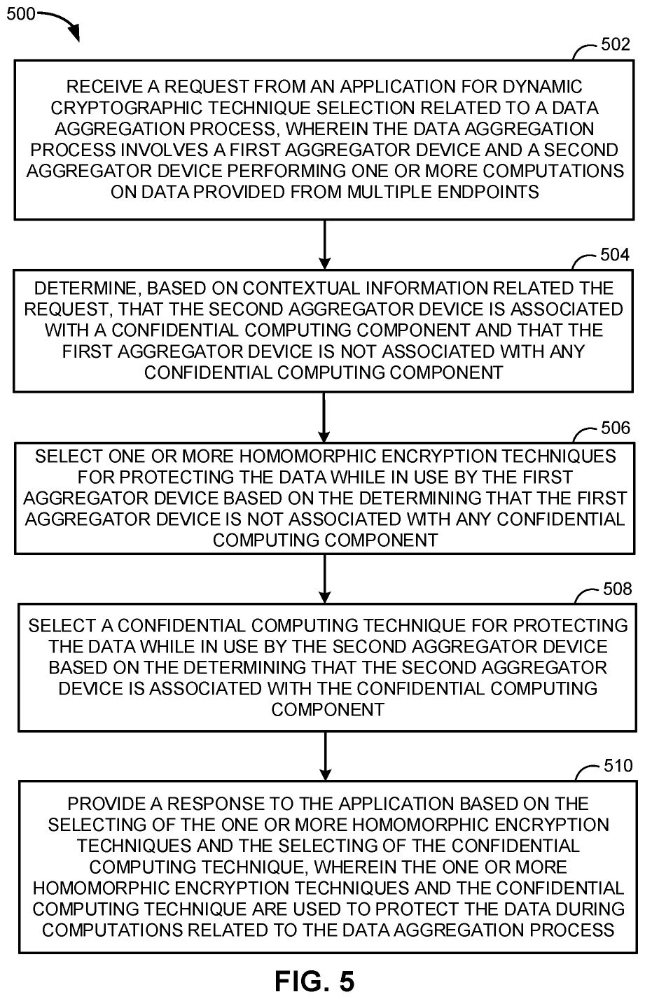

FIG. 5 depicts example operations 500 for cryptographic agility for multi-level privacy-preserving data aggregation according to embodiments of the present disclosure. For example, operations 500 may be performed by one or more components of the cryptographic agility system described above with respect to FIGS. 1-4.

Operations 500 begin at step 502, with receiving a request from an application for dynamic cryptographic technique selection related to a data aggregation process, wherein the data aggregation process involves a first aggregator device and a second aggregator device performing one or more computations on data provided from multiple endpoints.

Operations 500 continue at step 504, with determining, based on contextual information related the request, that the second aggregator device is associated with a confidential computing component and that the first aggregator device is not associated with any confidential computing component.

Operations 500 continue at step 506, with selecting one or more homomorphic encryption techniques for protecting the data while in use by the first aggregator device based on the determining that the first aggregator device is not associated with any confidential computing component.

Operations 500 continue at step 508, with selecting a confidential computing technique for protecting the data while in use by the second aggregator device based on the determining that the second aggregator device is associated with the confidential computing component.

Operations 500 continue at step 510, with providing a response to the application based on the selecting of the one or more homomorphic encryption techniques and the selecting of the confidential computing technique, wherein the one or more homomorphic encryption techniques and the confidential computing technique are used to protect the data during computations related to the data aggregation process.

In some embodiments, the selecting of the one or more homomorphic encryption techniques comprises selecting a first homomorphic encryption technique of the one or more homomorphic encryption techniques for use in encrypting a first subset of the data and selecting a second homomorphic encryption technique for use in encrypting a second subset of the data. In certain embodiments, the first subset of the data corresponds to a first endpoint group of the multiple endpoints and the second subset of the data corresponds to a second endpoint group of the multiple endpoints. In some embodiments, the first homomorphic encryption technique of the one or more homomorphic encryption techniques is selected based on one or more device capabilities or resource constraints of the first endpoint group and the second homomorphic encryption technique of the one or more homomorphic encryption techniques is selected based on one or more device capabilities or resource constraints of the second endpoint group.

In certain embodiments, the selecting of the one or more homomorphic encryption techniques is further based on one or more types of mathematical operations to be performed by the first aggregator device as part of the data aggregation process.

In some embodiments, one or more homomorphic encryption techniques are used to transmit encrypted data from the multiple endpoints to the first aggregator device, and wherein the first aggregator device performs a subset of the one or more computations on the encrypted data without decrypting the encrypted data.

In certain embodiments, one or more encryption keys related to the one or more homomorphic encryption techniques are provided to the confidential computing component associated with the second aggregator device, and wherein the one or more encryption keys are used to decrypt data within the confidential computing component for performing a subset of the one or more computations within the confidential computing component.

In some embodiments, a result of performing a subset of the one or more computations within the confidential computing component is transmitted to a third aggregator device.

In certain embodiments, the data, after being encrypted using the one or more homomorphic encryption techniques, is then wrapped in a transmission cipher for secure transmission to the first aggregator device as part of a two-layer encryption technique.

In some embodiments, a result of computations performed by the first aggregator device is then wrapped in a transmission cipher for secure transmission to the second aggregator device as part of a two-later encryption technique.

In certain embodiments, the two-layer encryption technique involves decrypting the transmission cipher outside of the confidential computing component, performing one or more operations within the confidential computing component, and then encrypting resulting content with a same or alternate transmission cipher outside of the confidential computing component.

In some embodiments, a result of performing a subset of the one or more computations within the confidential computing component is transmitted from the second aggregator device to a given endpoint of the multiple endpoints via a transmission path that is dynamically selected based on available bandwidth associated with one or more computing devices or networks so as to preserve bandwidth at one or more layers of communication.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of cryptographic agility for multi-level privacy-preserving data aggregation, comprising:
receiving a request from an application for dynamic cryptographic technique selection related to a data aggregation process, wherein the data aggregation process involves a first aggregator device and a second aggregator device performing one or more computations on data provided from multiple endpoints;
determining, based on contextual information related to the request, that the second aggregator device is associated with a confidential computing component and that the first aggregator device is not associated with any confidential computing component;
selecting one or more homomorphic encryption techniques for protecting the data while in use by the first aggregator device based on the determining that the first aggregator device is not associated with any confidential computing component;
selecting a confidential computing technique for protecting the data while in use by the second aggregator device based on the determining that the second aggregator device is associated with the confidential computing component; and
providing a response to the application based on the selecting of the one or more homomorphic encryption techniques and the selecting of the confidential computing technique, wherein the one or more homomorphic encryption techniques and the confidential computing technique are used to protect the data during computations related to the data aggregation process.

2. The method of claim 1, wherein the selecting of the one or more homomorphic encryption techniques comprises selecting a first homomorphic encryption technique of the one or more homomorphic encryption techniques for use in encrypting a first subset of the data and selecting a second homomorphic encryption technique for use in encrypting a second subset of the data.

3. The method of claim 2, wherein the first subset of the data corresponds to a first endpoint group of the multiple endpoints and the second subset of the data corresponds to a second endpoint group of the multiple endpoints.

4. The method of claim 3, wherein the first homomorphic encryption technique of the one or more homomorphic encryption techniques is selected based on one or more device capabilities or resource constraints of the first endpoint group and the second homomorphic encryption technique of the one or more homomorphic encryption techniques is selected based on one or more device capabilities or resource constraints of the second endpoint group.

5. The method of claim 1, wherein the selecting of the one or more homomorphic encryption techniques is further based on one or more types of mathematical operations to be performed by the first aggregator device as part of the data aggregation process.

6. The method of claim 1, wherein one or more homomorphic encryption techniques are used to transmit encrypted data from the multiple endpoints to the first aggregator device, and wherein the first aggregator device performs a subset of the one or more computations on the encrypted data without decrypting the encrypted data.

7. The method of claim 1, wherein one or more encryption keys related to the one or more homomorphic encryption techniques are provided to the confidential computing component associated with the second aggregator device, and wherein the one or more encryption keys are used to decrypt data within the confidential computing component for performing a subset of the one or more computations within the confidential computing component.

8. The method of claim 1, wherein a result of performing a subset of the one or more computations within the confidential computing component is transmitted to a third aggregator device.

9. The method of claim 1, wherein the data, after being encrypted using the one or more homomorphic encryption techniques, is then wrapped in a transmission cipher for secure transmission to the first aggregator device as part of a two-layer encryption technique.

10. The method of claim 1, wherein a result of computations performed by the first aggregator device is then wrapped in a transmission cipher for secure transmission to the second aggregator device as part of a two-layer encryption technique.

11. The method of claim 10, wherein the two-layer encryption technique involves decrypting the transmission cipher outside of the confidential computing component, performing one or more operations within the confidential computing component, and then encrypting resulting content with a same or alternate transmission cipher outside of the confidential computing component.

12. The method of claim 1, wherein a result of performing a subset of the one or more computations within the confidential computing component is transmitted from the second aggregator device to a given endpoint of the multiple endpoints via a transmission path that is dynamically selected based on available bandwidth associated with one or more computing devices or networks so as to preserve bandwidth at one or more layers of communication.

13. A system for cryptographic agility for multi-level privacy-preserving data aggregation, comprising:
at least one memory; and
at least one processor coupled to the at least one memory, the at least one processor and the at least one memory configured to:
receive a request from an application for dynamic cryptographic technique selection related to a data aggregation process, wherein the data aggregation process involves a first aggregator device and a second aggregator device performing one or more computations on data provided from multiple endpoints;
determine, based on contextual information related to the request, that the second aggregator device is associated with a confidential computing component and that the first aggregator device is not associated with any confidential computing component;
select one or more homomorphic encryption techniques for protecting the data while in use by the first aggregator device based on the determining that the first aggregator device is not associated with any confidential computing component;
select a confidential computing technique for protecting the data while in use by the second aggregator device based on the determining that the second aggregator device is associated with the confidential computing component; and
provide a response to the application based on the selecting of the one or more homomorphic encryption techniques and the selecting of the confidential computing technique, wherein the one or more homomorphic encryption techniques and the confidential computing technique are used to protect the data during computations related to the data aggregation process.

14. The system of claim 13, wherein the selecting of the one or more homomorphic encryption techniques comprises selecting a first homomorphic encryption technique of the one or more homomorphic encryption techniques for use in encrypting a first subset of the data and selecting a second homomorphic encryption technique for use in encrypting a second subset of the data.

15. The system of claim 14, wherein the first subset of the data corresponds to a first endpoint group of the multiple endpoints and the second subset of the data corresponds to a second endpoint group of the multiple endpoints.

16. The system of claim 15, wherein the first homomorphic encryption technique of the one or more homomorphic encryption techniques is selected based on one or more device capabilities or resource constraints of the first endpoint group and the second homomorphic encryption technique of the one or more homomorphic encryption techniques is selected based on one or more device capabilities or resource constraints of the second endpoint group.

17. The system of claim 16, wherein the selecting of the one or more homomorphic encryption techniques is further based on one or more types of mathematical operations to be performed by the first aggregator device as part of the data aggregation process.

18. The system of claim 13, wherein one or more homomorphic encryption techniques are used to transmit encrypted data from the multiple endpoints to the first aggregator device, and wherein the first aggregator device performs a subset of the one or more computations on the encrypted data without decrypting the encrypted data.

19. The system of claim 13, wherein one or more encryption keys related to the one or more homomorphic encryption techniques are provided to the confidential computing component associated with the second aggregator device, and wherein the one or more encryption keys are used to decrypt data within the confidential computing component for performing a subset of the one or more computations within the confidential computing component.

20. A non-transitory computer readable medium storing instructions that, when executed by one or more processors, cause the one or more processors to:
receive a request from an application for dynamic cryptographic technique selection related to a data aggregation process, wherein the data aggregation process involves a first aggregator device and a second aggregator device performing one or more computations on data provided from multiple endpoints;
determine, based on contextual information related to the request, that the second aggregator device is associated with a confidential computing component and that the first aggregator device is not associated with any confidential computing component;
select one or more homomorphic encryption techniques for protecting the data while in use by the first aggregator device based on the determining that the first aggregator device is not associated with any confidential computing component;
select a confidential computing technique for protecting the data while in use by the second aggregator device based on the determining that the second aggregator device is associated with the confidential computing component; and
provide a response to the application based on the selecting of the one or more homomorphic encryption techniques and the selecting of the confidential computing technique, wherein the one or more homomorphic encryption techniques and the confidential computing technique are used to protect the data during computations related to the data aggregation process.
